(19) United States
(12) Patent Application Publication
(10) Pub. No.: US 2023/0210089 A1
(43) Pub. Date: Jul. 6, 2023

(54) Herding Ball

(71) Applicant: Kemal Aktay, San Francisco, CA (US)

(72) Inventor: Kemal Aktay, San Francisco, CA (US)

(21) Appl. No.: 18/087,663

(22) Filed: Dec. 22, 2022

Related U.S. Application Data
(60) Provisional application No. 63/296,562, filed on Jan. 5, 2022.

(51) Int. Cl. A01K 15/02

(52) U.S. Cl. CPC A01K 15/027

(57) ABSTRACT

A herding ball has a pliable inner sphere and a spherical fabric cover. The pliable inner sphere has an outer surface and a port through which the pliable inner sphere may be filled with air. A plug is provided for plugging the port once the pliable inner sphere has been inflated. The spherical fabric cover is sized and shaped to fit around the pliable inner sphere, and provides a durable outer surface that includes a zipper closure. The zipper closure includes a slider having an attachment ring. A removable zipper pull includes a removable fastener for attachment to the attachment ring of the slider, and a pull that extends outwardly from the removable fastener.

### CROSS-REFERENCE TO RELATED APPLICATIONS

This application for a utility patent claims the benefit of U.S. Provisional Application No. 63/294,562, filed Dec. 29, 2021.

### BACKGROUND OF THE INVENTION

### Field of the Invention

This invention relates generally to dog toys, and more particularly to a herding ball.

### Description of Related Art

Herding dog breeds, such as Australian Shephard’s and Border Collies, enjoy herding, which is both enjoyable and also provides much needed exercise. Herding balls have been developed to enable these dogs to exercise and play while herding the ball, in much the same way they would herd sheep.

Existing herding balls tend to be quite small, typically about 10-14 inches, and are constructed of various types of foam, plastic, and hard rubber. Problems with these balls are that dogs typically can tear them up fairly quickly with their teeth, or by scratching at them, or just through constant hard use. Other problems are that the balls can sometimes damage a dog’s teeth, or cause excessive wearing of the teeth, especially if the ball is hard plastic and becomes scored through hard use.

The prior art teaches various small herding balls, and herding balls made of foam, plastic, and rubber. However, the prior art does not teach a herding ball that is much larger (at least 22 inches or larger), and constructed of a durable vinyl cover that resists damage despite hard use, and also protects the dog’s teeth from excessive wear damage. The present invention fulfills these needs and provides further advantages as described in the following summary.

### SUMMARY OF THE INVENTION

The present invention teaches certain benefits in construction and use which give rise to the objectives described below.

The present invention provides a spherical fabric cover for covering a pliable inner sphere for forming a herding ball. The spherical fabric cover has a durable outer surface that includes a closure for closing an aperture. The spherical fabric cover has a diameter of greater than 18 inches and is constructed of ballistic nylon.

In one embodiment, the herding ball includes a pliable inner sphere and a spherical fabric cover. The pliable inner sphere has an outer surface and a port through which the pliable inner sphere may be filled with air. A plug is provided for plugging the port once the pliable inner sphere has been inflated. The spherical fabric cover is sized and shaped to fit around the pliable inner sphere, and provides a durable outer surface that includes a zipper closure. The zipper closure includes a slider having an attachment ring. A removable zipper pull includes a removable fastener for attachment to the attachment ring of the slider, and a pull that extends outwardly from the removable fastener.

A primary objective of the present invention is to provide a herding ball having advantages not taught by the prior art.

Another objective is to provide a herding ball that is large enough to prevent a dog from biting the ball and potentially damaging the ball or his/her teeth.

A further objective is to provide a herding ball that is durable enough to withstand vigorous use by dogs without being easily torn or otherwise damaged.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a herding ball assembly according to one embodiment of the present invention, the herding ball assembly including a herding ball having a pliable inner sphere and a spherical fabric cover, and the assembly further including a pump device for inflating the herding ball.

FIG. 2 is a top plan view of the herding ball once the pliable inner sphere has been placed within the spherical fabric cover.

FIG. 3 is a close up of a nozzle of the pump device positioned through an aperture of a zipper closure of the spherical fabric cover and into a port of the pliable inner sphere for inflating the herding ball.

FIG. 4 is a close up view of the plug being inserted into the port for sealing the pliable inner sphere, once the nozzle has been removed from the port, once the herding ball has been fully inflated.

FIG. 5 is a close up view of a zipper pull being removed once the zipper closure has been fully closed.

FIG. 6 is a perspective view of a dog playing with the herding ball.

FIG. 7 is a close up perspective view of another embodiment of the zipper closure, which includes a double zipper construction.

### DETAILED DESCRIPTION OF THE INVENTION

The above-described drawing figures illustrate the invention, a herding ball that may be used as a toy and exercise device for dogs who wish to exercise their herding instincts by chasing, batting, guiding, and otherwise herding the herding ball.

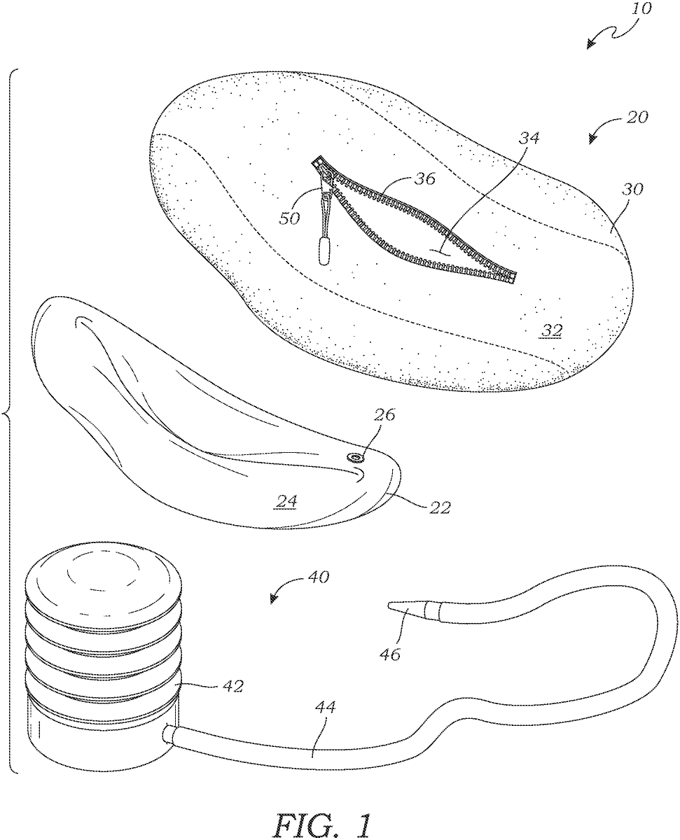

FIG. 1 is a perspective view of a herding ball assembly 10 according to one embodiment of the present invention, the herding ball assembly 10 including a herding ball 20 having a pliable inner sphere 22 and a spherical fabric cover 30, and the assembly further including a pump device 40 for inflating the herding ball 20. As shown in FIG. 1, the herding ball 20 is expected to be initially sold in a disassembled and deflated condition to reduce costs of shipping and storage. As described in greater detail below, the herding ball 20 can be quickly and easily assembled and inflated using the pump device 40 provided with the assembly.

As shown in FIG. 1, the herding ball comprises 20 the pliable inner sphere 22 having an outer surface 24 and a port 26 through which the pliable inner sphere 22 may be filled with air. In the current embodiment, the pliable inner sphere 22 may be constructed of PVC; however, the pliable inner sphere 22 may be constructed of any flexible or pliable materials, such as plastic, fabric, rubber, or other suitable materials that are suitable for inflation. The port 26 is preferably about 1 cm in diameter. As shown in FIG. 4, and discussed below, the pliable inner sphere 22 may further include a plug 28 for plugging the port 26 once the pliable inner sphere 22 has been inflated. For purposes of this application, the term “sphere” is defined to include sphere, spheroid, and similar shapes that are suitable for use as a herding ball.

As shown in FIG. 1, the spherical fabric cover 30 sized and shaped to fit around the pliable inner sphere 22. The spherical fabric cover 30 has a durable outer surface 32 that includes an aperture 34 that may be closed with a closure 36, in this case a zipper closure.

The spherical fabric cover 30 is formed of a tough, durable material that is capable of withstanding rough use by dogs, and resisting attempts by the dog to bite, gnaw, or otherwise damage the cover. In the current embodiment, the spherical fabric cover 30 is formed of ballistic nylon, in one embodiment it is formed of 1680 denier nylon, and in another 2520D may be used. While these materials are currently preferred, those skilled in the art may select alternative materials that are also suitable, and these materials should be considered within the scope of the present invention.

It is preferred that the herding ball 20 be resistant to any attempt by a dog to grip or bite any portion of the herding ball 20; therefore, the spherical fabric cover 30 preferably has a diameter of greater than 18 inches. In the current embodiment, the diameter is either 18, 22 inches or 30 inches, which size is suitable being determined by the size of the dog. Furthermore, the spherical fabric cover 30 preferably does not have any protruding features that extend more than 1 cm from the surface of the spherical fabric cover 30, so there is nothing a dog can grip between his or her teeth. For this reason, there is no permanently attached zipper pull, which would extend too far, and instead the invention uses a unique removable zipper pull, discussed in greater detail below. Furthermore, the outer surface of the spherical fabric cover 30 is sewn to prevent the formation of any protrusions, flaps, or folds, which might be gripped and torn by the dog during use.

As shown in FIG. 1, the herding ball assembly 10 preferably includes a pump device 40 having a pump actuator 42 and a hose 44 that extends from the pump actuator 42 to a nozzle 46. The nozzle 46 is adapted for engaging the port 26 of the pliable inner sphere 22 for filling the pliable inner sphere 22 with air. While the inclusion of the pump device 40 is preferred in the present embodiment, it is possible that this may be omitted in some embodiments, and the user may use other devices or systems to inflate the herding ball 20. It may also be sold fully inflated in some embodiments, although this is not currently preferred due to high costs in shipping and storage.

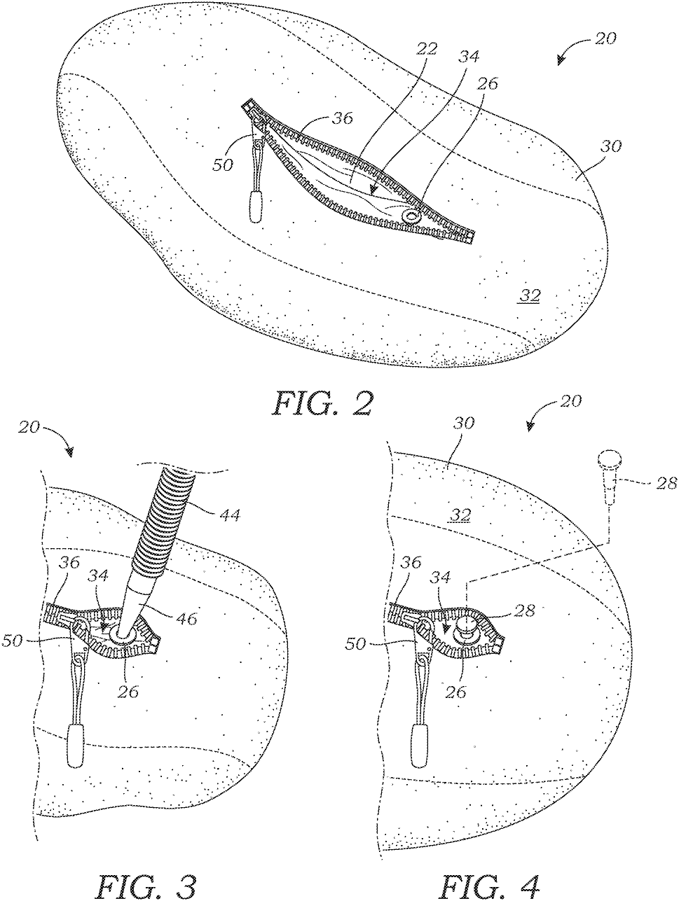

FIG. 2 is a top plan view of the herding ball 20 once the pliable inner sphere 22 has been placed within the spherical fabric cover 30. As shown in FIG. 2, the pliable inner sphere 22 is easily inserted through the aperture 34 formed by the zipper closure 36, preferably so that the port 26 of the pliable inner sphere 22 is positioned at the end of the zipper closure 36, and readily accessible therethrough.

FIG. 3 is a close up of a nozzle 46 of the pump device 40 positioned through the zipper closure 36 of the spherical fabric cover 30 and into the port 26 of the pliable inner sphere 22 for inflating the herding ball 20. As shown in FIG. 3, the pump device 40 may then be used to inflate the pliable inner sphere 22, which then inflates the spherical fabric cover 30.

FIG. 4 is a close up view of the plug 28 being inserted into the port 26 for sealing the pliable inner sphere 22, once the nozzle 46 has been removed from the port 26, once the herding ball 20 has been fully inflated. As shown in FIG. 4, once the plug 28 has been inserted, the pliable inner sphere 22 will remain inflated, and the zipper closure 36 can then be fully closed.

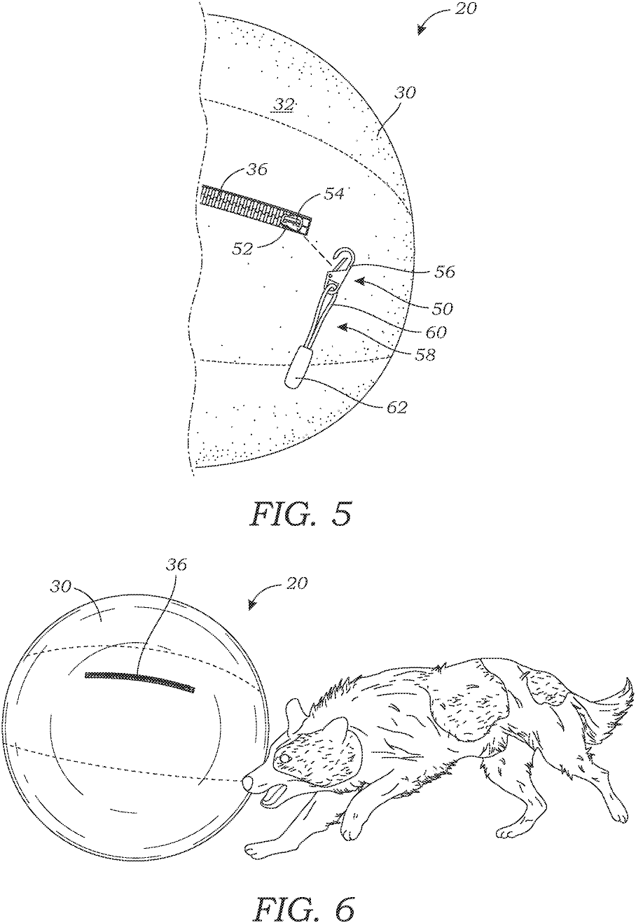

FIG. 5 is a close up view of a removable zipper pull 50 being removed once the zipper closure 36 has been fully closed. As shown in FIG. 5, the removal of the zipper pull 50 makes sure there are no protruding parts which the dog can grip or chew, preventing the dog from damaging the ball, or his/her teeth. In this embodiment, the zipper closure 36 includes a slider 52 having an attachment ring 54, and the removable zipper pull 50 that includes a removable fastener 56 for attachment to the attachment ring 54 of the slider 52. A pull extends outwardly from the removable fastener by at least 2 cm.

In the embodiment of FIG. 5, the removable fastener 56 of the zipper pull 50 is a snap hook; however, other removable fasteners (e.g., mechanical fasteners such as clamps, rings, snaps, and other forms of hooks, as well as non-mechanical fasteners such as magnets) may alternatively be used, and should be considered within the scope of the present invention.

In this embodiment, a flexible pull 58 of the removable zipper pull 50 includes a cord 60 that is at least 2 cm and further includes an elongate gripper body 62 attached to the cord. The elongate gripper body 62 may be structured to enable a user to easily grasp the gripper body between his or her finger and thumb, constructed of molded plastic, rubber, or other easily grippable material.

FIG. 6 is a perspective view of a dog playing with the herding ball 20. As shown in FIG. 6, the fully inflated herding ball 20 should be large enough so that the dog cannot grip the ball with his or her teeth. The rugged material of the spherical fabric cover 30 prevents the dog from gripping the ball, or scratching or otherwise damaging it. The herding ball 20 is well suited for the dog to bat the ball, chase it, and otherwise herd it as the dog might a sheep.

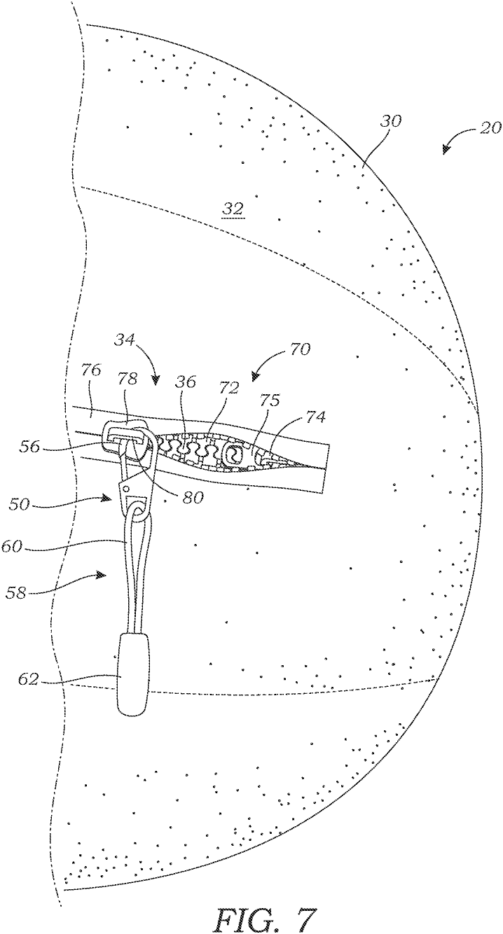

FIG. 7 is a close up perspective view of another embodiment of a zipper closure 70, which includes a double zipper construction. In this embodiment, the aperture 34 is first closed with an inner locking zipper 72 that includes a locking pull 74 that includes a fixedly attached tab 75 that, when down, locks the zipper 72. The locking pull 74 functions to lock the inner locking zipper 72 in a closed position when the tab 75 is lowered to a locking position, as shown in FIG. 7.

Once the inner locking zipper 72 is locked closed, an outer zipper tape 76 is closed over the inner locking zipper 72. The outer zipper tape 76 has an outer slider 78 having an outer attachment ring 80 to which the removable zipper pull 50 may be removably attacked, but no permanent pull.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/- 10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A spherical fabric cover for covering a pliable inner sphere for forming a herding ball, the spherical fabric cover comprising:
a spherical fabric cover sized and shaped to fit around the pliable inner sphere, the spherical fabric cover having a durable outer surface that includes a aperture which may be closed by a zipper closure;
wherein the zipper closure includes a slider having an attachment ring; and
a removable zipper pull that includes a removable fastener for attachment to the attachment ring of the slider, and a pull that extends outwardly from the removable fastener by at least 2 cm.

2. The herding ball of claim 1, further comprising a pump device having a pump actuator and a hose that extends from the pump actuator to a nozzle, the nozzle being adapted for engaging the port of the pliable inner sphere for filling the pliable inner sphere with air.

3. The herding ball of claim 1, wherein the spherical fabric cover is formed of ballistic nylon.

4. The herding ball of claim 1, wherein the spherical fabric cover is formed of 1680 denier nylon.

5. The herding ball of claim 1, wherein the removable fastener of the removable zipper pull is a snap hook.

6. The herding ball of claim 1, wherein the flexible pull of the removable zipper pull includes a cord that is at least 2 cm and further includes an elongate gripper body attached to the cord, the elongate gripper body being structured to enable a user to easily grasp the gripper body between his or her finger and thumb.

7. The herding ball of claim 1, wherein the spherical fabric cover does not have any protruding features that extend more than 1 cm, so there is nothing a dog can grip between his or her teeth.

8. A herding ball comprising:
a pliable inner sphere having an outer surface and a port through which the pliable inner sphere may be filled with air;
a plug for plugging the port once the pliable inner sphere has been inflated;
a spherical fabric cover sized and shaped to fit around the pliable inner sphere, the spherical fabric cover having a durable outer surface that includes a zipper closure;
wherein the zipper closure includes a slider having an attachment ring; and
a removable zipper pull that includes a removable fastener for attachment to the attachment ring of the slider, and a pull that extends outwardly from the removable fastener.

9. The herding ball of claim 8, further comprising a pump device having a pump actuator and a hose that extends from the pump actuator to a nozzle, the nozzle being adapted for engaging the port of the pliable inner sphere for filling the pliable inner sphere with air.

10. The herding ball of claim 8, wherein the spherical fabric cover is formed of ballistic nylon.

11. The herding ball of claim 8, wherein the spherical fabric cover is formed of 1680 denier nylon.

12. The herding ball of claim 8, wherein the removable fastener of the removable zipper pull is a snap hook.

13. The herding ball of claim 8, wherein the flexible pull of the removable zipper pull includes a cord that is at least 2 cm and further includes an elongate gripper body attached to the cord, the elongate gripper body being structured to enable a user to easily grasp the gripper body between his or her finger and thumb.

14. The herding ball of claim 8, wherein the spherical fabric cover does not have any protruding features that extend more than 1 cm, so there is nothing a dog can grip between his or her teeth.

15. The herding ball of claim 8, wherein the spherical fabric cover has a diameter of greater than 18 inches.

16. The herding ball of claim 8, wherein the zipper closure includes an inner locking zipper and an outer zipper tape.

17. A spherical fabric cover for covering a pliable inner sphere for forming a herding ball, the spherical fabric cover comprising:
a spherical fabric cover sized and shaped to fit around the pliable inner sphere, the spherical fabric cover having a durable outer surface that includes a closure;
wherein the spherical fabric cover has a diameter of greater than 18 inches and is constructed of ballistic nylon.

18. The herding ball of claim 17, wherein the spherical fabric cover does not have any protruding features that extend more than 1 cm.
